(19) United States
(12) Patent Application Publication
(10) Pub. No.: US 2026/0103190 A1
(43) Pub. Date: Apr. 16, 2026

(54) METHOD FOR TRAINING A MACHINE LEARNING MODEL

(71) Applicant: Artem Maksimovich VOLKOV, Moscow (RU)

(72) Inventor: Artem Maksimovich VOLKOV, Moscow (RU)

(21) Appl. No.: 18/950,113

(22) Filed: Nov. 17, 2024

(30) Foreign Application Priority Data
Oct. 10, 2024 (RU) 2024130475

(51) Int. Cl. B60W 30/095; B60W 30/09; B60W 50/06

(52) U.S. Cl. CPC B60W 30/0956; B60W 30/09; B60W 30/0953; B60W 50/06; B60W 2554/4029; B60W 2554/80

(57) ABSTRACT

The technical solution relates to the field of transport, in particular, to auxiliary devices and methods for collecting data for machine learning using vehicles, such as, for example, personal mobility devices (PMD). A method for training a machine learning model is proposed. There is a need to speed up the preparation of data suitable for machine learning and thus reduce the time it takes to prepare machine learning models trained on big data. The technical result achieved by implementing the claimed technical solution, in addition to the implementation of the product and/or method for its intended purpose, is an increase in the speed of preparing data suitable for machine learning, including an increase in the speed of preparing big data that can be used for machine learning. In some aspects, another technical result achieved is also an increase in road safety.

### FIELD OF INVENTION

The present invention relates to transport, particularly to auxiliary devices and methods for collecting data for machine learning using vehicles, such as, for example, personal mobility devices (PMDs).

### DESCRIPTION OF THE RELATED ART

There are a number of methods for collecting data for machine learning known in the art, including those involving vehicles and their various environmental sensors. The data collected in this way can be raw data (i.e. not marked up or modified, which makes them valueless until they are marked up or modified and thus made valuable) that are then marked up or modified in order to be used for machine learning, for example, to create a neural network that can be used to predict maximum permissible speed based on the environmental data obtained. At the same time, there are no known solutions that allow raw data to be marked up and/or modified and/or deleted and/or not written immediately as they are collected.

For instance, patent document DE102012220011B4, published on Nov. 17, 2022 (D1) discloses and operating device for operating an electric bicycle having: a detection device which is designed to detect sensor data; a computer device which is coupled to the detection device and which is designed to determine at least one environmental parameter based on the detected sensor data; and an interface device which is coupled to the computer device and which is designed to control an electric motor of the electric bike and to limit a speed of the electric bike on the basis of the determined at least one environmental parameter. The solution known from D1 does not allow the data assessor (a data collection specialist) to interact with the raw data immediately as they are collected, so that any and all data collected in this way require further cleanup consisting of, but not limited to, marking up and/or modifying and/or even deleting the data, which inevitably affects the speed of machine learning, as well as its accuracy and efficiency, since accurate and efficient machine learning requires a sufficient amount of data suitable for machine learning which takes time to prepare, which is especially important when using neural networks trained on big data.

There is, therefore, the need in the field to speed up the preparation of data suitable for machine learning, thus shortening the time required to train machine learning models on big data.

The solution disclosed in D1 can be considered the closest prior art to the claimed invention.

### SUMMARY OF THE INVENTION

The technical problem to be solved by the claimed invention is to provide a product and/or a method and/or a use of said product or method that do not possess the drawbacks of the prior art and thus make it possible to speed up the preparation of data suitable for machine learning, including speeding up the preparation of big data that can be used for machine learning. In some aspects of the claimed invention, the technical problems also include the provision of a product and/or a method and/or a use that provide increased road safety. Another technical problem to be solved by the claimed invention is to provide a product and/or a method and/or a use that expand the available technical means, such as methods for collecting data for machine learning and/or methods for controlling and/or determining a maximum permissible speed for a vehicle.

The objective of the claimed invention, in addition to the product and/or method fulfilling their purpose, is to speed up the preparation of data suitable for machine learning, including speeding up the preparation of big data that can be used for machine learning. In some aspects of the claimed invention, the objectives also include the provision of increased road safety.

The objective of the present invention is achieved by a method for training a machine learning model, executed by a processor or processors of a computer device, the method comprising using the at least one processor of the at least one computer device to train the machine learning model to determine a permissible movement speed for a vehicle based on an environment frame that is inputted into the machine learning model; wherein the environment frame is obtained by means of a vehicle equipped with at least one environmental sensor adapted to capture environment frames; wherein the machine learning model is trained using data that have been obtained using a method for data collection, the method comprising at least the following steps: obtaining raw data for machine learning using the at least one environmental sensor, and writing at least a portion of the raw data obtained to a machine-readable storage medium using a data collection device; and wherein, in the process of data collection, a control signal for the data collection device is generated, the control signal containing at least one instruction for the processor of the data collection device, the at least one instruction is capable of prompting said processor to execute a program code which, when executed by the processor, interacts with at least a portion of the raw data being collected.

### BRIEF DESCRIPTION OF THE DRAWINGS

Exemplary embodiments of the present utility model are described in further detail below with references made to the attached drawings, included herein by reference:

FIG. 1. shows exemplary diagrams of systems 100, 200 for collecting data for machine learning, a diagram of system 300 for training machine learning models, and a diagram of system 400 for controlling a vehicle.

### DETAILED DESCRIPTION OF THE PREFERRED EMBODIMENTS

In the present disclosure, the term “big data”, preferably, but not limited to, refers to large amounts of data, primarily distinguished by their volume, diversity, speed of processing and/or variability that require scaling technology in order to be efficiently stored, processed, managed and analyzed, as provisioned, for example, but not limited to, in ISO/IEC 20546:2019, GOST R ISO/IEC 20546-2021 and other standards.

In the present disclosure, the term “maximum permissible speed”, preferably, but not limited to, refers to a maximum threshold movement speed value for a vehicle, determined by the applicable regulatory restrictions for the given vehicle on the given section of the route along which the motorized vehicle is moving, without, preferably, but not limited to, taking into account any non-fined limits exceeding the maximum permissible speed.

In the present disclosure, the term “permissible speed”, preferably, but not limited to, refers to the value or a range of values of movement speed of a vehicle that may or may not include the maximum permissible speed of said vehicle.

In the present disclosure, the term “raw data”, preferably, but not limited to, refers to the data that have not been cleaned up and/or marked up and/or modified and cannot be suitable for machine learning until they are cleaned up and/or marked up and/or modified, but can become suitable for machine learning after they are cleaned up and/or marked up and/or modified.

In the present disclosure, the term “traffic flow”, preferably, but not limited to, refers to a plurality of vehicles that are normally present on a given section of the route at a given time of day and, preferably, but not limited to, are moving along the given section of the route without exceeding the maximum permissible speed in accordance with the regulatory restrictions applicable to them or restrictions determined by the logical thinking of the drivers of said vehicles.

In the present disclosure, the term “pedestrian and traffic flow”, preferably, but not limited to, refers to a traffic flow that also includes pedestrians that are normally present on a given section of the route and, preferably, but not limited to, are moving along the given section of the route in accordance with the regulatory restrictions applicable to them or restrictions determined by the logical thinking of the pedestrians themselves.

In the present disclosure, the term “electric personal mobility device”, or “EPMD”, preferably, but not limited to, refers to a vehicle having one or more motors and designed to carry a maximum of one person by using at least one electric motor with a maximum permissible speed of not more than 25 km/h for sections of the route outside residential areas or yard areas and with a maximum permissible speed of not more than 20 km/h for sections of the route within residential areas or yard areas, unless otherwise restricted.

In the present disclosure, the term “electric bike” refers to a bicycle equipped with at least one electric motor used to propel the electric bike and/or reduce the effort spend on propelling the electric bike with a maximum permissible speed of not more than 60 km/h for sections of the route outside residential areas or yard areas and with a maximum permissible speed of not more than 20 km/h for sections of the route within residential areas or yard areas, unless otherwise restricted.

According to a preferred embodiment of the present invention, there is provided a method for collecting data for machine learning, the method comprising at least obtaining raw data for machine learning using at least one environmental sensor, and writing at least a portion of the raw data obtained to a machine-readable storage medium using a data collection device; wherein, in the process of data collection, a control signal for the data collection device collecting data for machine learning is generated, the control signal containing at least one instruction for the processor in the data collection device that is capable of prompting said processor to execute the program code which, when executed by the processor, interacts with at least a portion of the raw data being collected.

In an exemplary embodiment of the present invention, there is provided any of the disclosed methods for collecting data, wherein the interactions include at least marking up and/or modifying at least a portion of the raw data being written to the machine-readable storage medium, and/or deleting at least a portion of the raw data and/or data suitable for machine learning written to the machine-readable storage medium, and/or not writing at least a portion of the raw data being collected to the machine-readable storage medium.

In an exemplary embodiment of the present invention, there is provided any of the disclosed methods for collecting data, wherein the data are collected using a data collection device that is connected to the at least one environmental sensor and/or comprises the at least one environmental sensor.

In an exemplary embodiment of the present invention, there is provided any of the disclosed methods for collecting data, wherein the environmental sensor is selected from or is formed by a radar, a lidar, a sonar, a camera, or a combination thereof.

In an exemplary embodiment of the present invention, there is provided any of the disclosed methods for collecting data, wherein the environmental sensor is moved around by means of the data-collecting vehicle.

In an exemplary embodiment of the present invention, there is provided any of the disclosed methods for collecting data, wherein movement is performed at least concurrently with the regular traffic flow and/or the regular pedestrian and traffic flow, wherein the movement speed is selected so as not to exceed the maximum permissible speed for a vehicle on the given section of the route.

In an exemplary embodiment of the present invention, there is provided any of the disclosed methods for collecting data, wherein the movement speed is changed at least depending on the distance to the obstacle.

In an exemplary embodiment of the present invention, there is provided any of the disclosed methods for collecting data, wherein the control signal is generated when the movement speed does not correspond to the maximum permissible speed for a vehicle on the given section of the route, wherein the distance to the obstacle is selected so as to allow the movement speed to correspond to the maximum permissible speed for a vehicle on the given section of the route.

In an exemplary embodiment of the present invention, there is provided any of the disclosed methods for collecting data, wherein the control signal is generated when there is no movement and/or the movement is performed without using the engine, at a speed not exceeding 1.4 m/s.

In an exemplary embodiment of the present invention, there is provided any of the disclosed methods for collecting data, wherein the control signal is generated by means of a signaling device that is connected to or equipped on the data collection device.

In an exemplary embodiment of the present invention, there is provided any of the disclosed methods for collecting data, wherein the data collecting vehicle is an electric personal mobility device or an electric bike.

In an exemplary embodiment of the present invention, there is provided any of the disclosed methods for collecting data, wherein the vehicle is temporarily rented, the use of said vehicle being provided by means of the system for enabling personal use of vehicles on demand.

According to another preferred embodiment of the present invention, there is provided a data collection device for collecting data for machine learning, the device comprising at least one or more processors, and a memory that stores the program code which, when executed by the processor, prompts it to run, in any order, at least the following processes: obtaining raw data from at least one environmental sensor, writing at least a portion of the raw data obtained to a machine-readable storage medium, and receiving a control signal, followed by at least interacting with at least a portion of the raw data being collected.

In an exemplary embodiment of the present invention, there is provided any of the disclosed data collection devices, wherein the interactions include at least marking up and/or modifying at least a portion of the raw data being written to the machine-readable storage medium, and/or deleting at least a portion of the raw data and/or data suitable for machine learning written to the machine-readable storage medium, and/or not writing at least a portion of the raw data being collected to the machine-readable storage medium.

In an exemplary embodiment of the present invention, there is provided any of the disclosed data collection devices, wherein the environmental sensor is selected from or is formed by a radar, a lidar, a sonar, a camera, or a combination thereof.

In an exemplary embodiment of the present invention, there is provided any of the disclosed data collection devices, wherein the environmental sensor is an external device connected to the data collection device via a communication line.

In an exemplary embodiment of the present invention, there is provided any of the disclosed data collection devices, wherein the environmental sensor is the environmental sensor of the data-collecting vehicle or is mounted on the data-collecting vehicle.

In an exemplary embodiment of the present invention, there is provided any of the disclosed data collection devices, wherein the device contains an environmental sensor.

In an exemplary embodiment of the present invention, there is provided any of the disclosed data collection devices, wherein the device is adapted to be used while the vehicle is moving.

In an exemplary embodiment of the present invention, there is provided any of the disclosed data collection devices, wherein the environmental sensor is moved around by means of a vehicle.

In an exemplary embodiment of the present invention, there is provided any of the disclosed data collection devices, wherein the environmental sensor is moved around as was described above with reference to the method for collecting data.

In an exemplary embodiment of the present invention, there is provided any of the disclosed data collection devices, wherein the control signal is generated as was described above with reference to the method for collecting data.

In an exemplary embodiment of the present invention, there is provided any of the disclosed data collection devices, wherein the machine-readable storage medium to which the raw data are written is the memory of the data collection device.

In an exemplary embodiment of the present invention, there is provided any of the disclosed data collection devices, wherein the machine-readable storage medium to which the raw data are written is external to the data collection device and is connected to it via a data transfer interface or a wireless communication line.

In an exemplary embodiment of the present invention, there is provided any of the disclosed data collection devices, wherein the control signal is generated by means of a signaling device.

In an exemplary embodiment of the present invention, there is provided any of the disclosed data collection devices, wherein the signaling device is not part of the data collection device and is connected to it via a communication line.

In an exemplary embodiment of the present invention, there is provided any of the disclosed data collection devices, wherein the signaling device is part of the data collection device.

In an exemplary embodiment of the present invention, there is provided any of the disclosed data collection devices, wherein the signaling device contains a switching means that causes the control signal for the data collection device to be generated when triggered.

According to another preferred embodiment of the present invention, there is provided a system for collecting data for machine learning, the system comprising one or more disclosed data collection devices adapted to generate at least one dataset for machine learning from the data written to the machine-readable storage medium and to send the generated dataset via a wireless communication line; a server connected to one or more disclosed data collection devices via a wireless communication line, the server comprising at least one or more server's processors, a memory that stores the program code which, when executed by the server's processor, enables it at least to obtain the at least one dataset and write the obtained dataset to the server's memory; wherein the at least one dataset contains at least one of the raw data, marked up raw data, modified raw data, or a combination thereof; and wherein said dataset does not contain at least the deleted raw data or the data not written to the machine-readable storage medium.

According to another preferred embodiment of the present invention, there is provided a vehicle for collecting data for machine learning, the vehicle comprising at least one environmental sensor connected to at least one of the disclosed data collection devices.

In an exemplary embodiment of the present invention, there is provided any of the disclosed data-collecting vehicles, wherein the vehicle is an electric personal mobility device or an electric bike.

In an exemplary embodiment of the present invention, there is provided any of the disclosed data-collecting vehicles, wherein the vehicle is equipped with at least one of the disclosed data collection devices.

According to another preferred embodiment of the present invention, there is provided a method for collecting data for machine learning, characterized in that a disclosed vehicle is used to move a disclosed environmental sensor along a section of the route, wherein a disclosed control signal for a disclosed data collection device is generated in a disclosed way.

According to another preferred embodiment of the present invention, there is provided a system for collecting data for machine learning, the system comprising one or more disclosed data collection devices adapted to generate at least one dataset for machine learning from the data written to the machine-readable storage medium and to send the generated dataset via a wireless communication line; a server connected to one or more disclosed data collection devices via a wireless communication line, the server comprising at least one or more server's processors, a memory that stores the program code which, when executed by the server's processor, enables it at least to obtain the at least one dataset and write the obtained dataset to the server's memory; wherein the at least one dataset contains at least one of the raw data, marked up raw data, modified raw data, or a combination thereof; wherein said dataset does not contain at least the deleted raw data or the data not written to the machine-readable storage medium; and wherein the system contains one or more vehicles equipped with any disclosed data collection device.

According to another preferred embodiment of the present invention, there is provided a method for training a machine learning model, executed by a processor of a computer device, the method comprising using at least one processor of at least one computer device to train the machine learning model to determine a permissible movement speed for a vehicle based on an environment frame that is inputted into the machine learning model; wherein the environment frame is obtained by means of a vehicle equipped with at least one environmental sensor adapted to capture environment frames; and wherein the machine learning model is trained using the data obtained using any of the disclosed methods for collecting data.

In an exemplary embodiment of the present invention, there is provided any of the disclosed methods for training a machine learning model, wherein the machine learning model is trained to solve a regression problem.

According to another preferred embodiment of the present invention, there is provided a device for training a machine learning model, the device comprising at least one or more processors, and a memory that stores the program code which, when executed by the processor in the device for training a machine learning model, prompts it to execute any of the disclosed methods for training a machine learning model.

According to another preferred embodiment of the present invention, there is provided a system for training a machine learning model, the system comprising at least one or more devices for training a machine learning model, and one or more of the disclosed data-collecting vehicles for collecting data for machine learning, which can be used for executing any of the disclosed methods for collecting data for machine learning; wherein the device is adapted to use at least the data obtained using said methods to train a machine learning model.

According to another preferred embodiment of the present invention, there is provided a machine-readable storage medium that stores the program code which, when executed by at least one processor of at least one computer device, enables it to execute any of the disclosed methods for training a machine learning model, and/or that stores a machine learning model trained using any of the disclosed methods for training a machine learning model.

According to another preferred embodiment of the present invention, there is provided a method for determining a permissible movement speed for a vehicle, executed by a processor of a computer device, the method comprising using at least one processor of at least one computer device to input an environment frame into the machine learning model, trained using any of the disclosed methods for training a machine learning model, and receiving the permissible movement speed value for a vehicle based on the given environment frame as output.

According to another preferred embodiment of the present invention, there is provided a device for determining the permissible speed for a vehicle, the device comprising at least one or more processors, and a memory that stores the program code which, when executed by the processor, prompts it to execute any of the disclosed methods for determining a permissible movement speed for a vehicle.

According to another preferred embodiment of the present invention, there is provided a system for determining the permissible speed for a vehicle, the system comprising at least one or more of the disclosed devices for determining the permissible speed for a vehicle, and one or more vehicles connected to any of the disclosed devices for determining the permissible speed for a vehicle and equipped with at least one environmental sensor adapted to capture any of the disclosed environment frames.

According to another preferred embodiment of the present invention, there is provided a machine-readable storage medium that stores the program code which, when executed by at least one processor of at least one computer device, enables it to execute any of the disclosed methods for determining a permissible movement speed for a vehicle.

According to another preferred embodiment of the present invention, there is provided a method for controlling a vehicle, the method comprising using at least one processor of at least one computer device to at least identify at least one environment frame; determining, using any of the disclosed methods for determining a permissible movement speed for a vehicle, the permissible movement speed for a vehicle based on the identified environment frame; and at least generating a control signal for the control system of a vehicle, the signal containing at least a setting that includes the determined permissible movement speed for the vehicle based on the given environment frame, which is stored in the memory of the computer device of the control system of the vehicle.

According to another preferred embodiment of the present invention, there is provided a vehicle controller that comprises at least one or more processors, and a memory that stores the program code which, when executed by the processor in the controller, prompts it to execute any of the disclosed methods for controlling a vehicle.

According to another preferred embodiment of the present invention, there is provided a system for controlling a vehicle that comprises at least an engine adapted to actuate at least one motor, and at least one of the disclosed vehicle controllers, adapted at least to generate a control signal for the engine and/or adapted at least to generate an information signal for the information system of the vehicle; wherein the control signal is generated using the disclosed setting, and wherein the information signal is generated using the disclosed setting.

According to another preferred embodiment of the present invention, there is provided a machine-readable storage medium that stores the program code which, when executed by at least one processor of at least one computer device, enables it to execute any of the disclosed methods for controlling a vehicle.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

According to a preferred embodiment of the present invention, there is provided a method for collecting data for machine learning, the method comprising at least obtaining raw data for machine learning using at least one environmental sensor, and writing at least a portion of the raw data obtained to a machine-readable storage medium using a data collection device; wherein, in the process of data collection, a control signal for the data collection device collecting data for machine learning is generated, the control signal containing at least one instruction for the processor in the data collection device that is capable of prompting said processor to execute the program code which, when executed by the processor, interacts with at least a portion of the raw data being collected. In addition, preferably, but not limited to, the interactions include at least marking up and/or modifying at least a portion of the raw data being written to the machine-readable storage medium, and/or deleting at least a portion of the raw data and/or data suitable for machine learning written to the machine-readable storage medium, and/or not writing at least a portion of the raw data being collected to the machine-readable storage medium. For example, but not limited to, this may allow to collect data, which are raw data, such as for example, but not limited to, environment frames that are obtained by means of one or more environmental sensors. In addition, but not limited to, an environment frame can be a static rendition of the situation in the area covered by the environmental sensor. For example, but not limited to, the environmental sensor is selected from or is formed by a radar, a lidar, a sonar, a camera, or a combination thereof. For example, but not limited to, if the environmental sensor is a camera, then the environment frame is an image obtained by means of said camera using, but not limited to, photo or video shooting, including images that are video frames. For example, if the environmental sensor is a lidar, then the environment frame is at least a point cloud obtained by means of said lidar, that is at least suitable for creating a 3D scene for subsequent analysis. For example, if the environmental sensor is a radar or a sonar, then the environment frame is at least a set of reflected signals obtained by means of said radar or sonar, that at least allows to detect objects and distances to them. At the same time, but not limited to, it should be obvious to a person having ordinary skill in the art that the environmental sensor can be any suitable combination of the environmental sensors disclosed herein, provided that for example, but not limited to, environment frames of one kind can be complemented by features extracted from environment frames of other kinds thus resulting in the environment frames that are more complete and therefore enriched; wherein, but not limited to, it should be generally noted that the environment frame should at least contain a rendition of the space of the area covered by the sensor, wherein said space does not necessarily contain other objects, such as for example, but not limited to, obstacles on or near the movement trajectory of the vehicle, such as for example, but not limited to, other vehicles and/or pedestrians and/or other objects that are normally present or encountered on the given section of the route.

Preferably, but not limited to, the data are collected using a data collection device that is connected to the at least one environmental sensor and/or comprises the at least one environmental sensor. Preferably, but not limited to, the environmental sensor is moved around by means of the data-collecting vehicle; wherein, preferably, it is moved in a given way along a given route that consists of at least one section. Preferably, but not limited to, the vehicle for collecting data for machine learning is a vehicle comprising at least one environmental sensor connected to at least one of the disclosed data collection devices. At the same time, but not limited to, it should be obvious to a person having ordinary skill in the art that the vehicle can be any vehicle that is suitable for being operated alongside the environmental sensor and/or the data collection device, including, but not limited to, both manned and unmanned vehicles. For example, but not limited to, the vehicle is an electric personal mobility device (EPMD) or an electric bike; wherein, for example, but not limited to, the electric personal mobility device can be either an electric kick scooter, an electric skateboard, a gyro scooter, a Segway, an electric unicycle, etc.

For example, but not limited to, the environmental sensor is moved around at least concurrently with the regular traffic flow and/or the regular pedestrian and traffic flow. In addition, but not limited to, the movement speed is selected so as not to exceed the maximum permissible movement speed for the vehicle on the given section of the route. For example, but not limited to, the environmental sensor is mounted on any suitable EPMD so that a plurality of environment frames can be obtained angled in the direction of the EPMD's movement, and after that movement is performed along a given route within an urban area, during which data are collected by means of the environmental sensor. In addition, for example, but not limited to, a route can be provided that includes several connected sections characterized for example, but not limited to, by different density of their pedestrian and traffic flows and/or characterized for example, but not limited to, by different maximum speeds for EPMDs. For example, but not limited to, a route may be provided that consists of at least two sections, one of which lies within a residential area or a yard area, and the other lies outside a residential area or a yard area. This, for example, but not limited to, may ensure the required variability of the data being collected. Alternatively, for example, but not limited to, a route can be provided that consists of at least two sections, one of which includes a dedicated lane for EPMDs, and the other does not include such a dedicated lane thus requiring more careful driving. Therefore, for example, but not limited to, the environmental sensor can be mounted on an electric kick scooter and a corresponding route can be provided so as to ensure the required variability of the data being collected. In addition, for example, but not limited to, the movement speed is changed at least depending on the distance to the obstacle, such as for example, but not limited to, another vehicle and/or pedestrian and/or another obstacle located on or near the movement trajectory of the data-collecting vehicle, or, but not limited to, it can be changed depending on the direction of movement; wherein preferably, but not limited to, the speed is changed so as to ensure a safe movement that minimizes as far as possible the risks of a traffic accident involving the data-collecting vehicle, which, preferably, is achieved by moving in accordance with the traffic regulations specified for the data-collecting vehicle. In addition, but not limited to, a predominantly straight-line movement is provided within the given section of the route, taking into account the obstacles formed by the objects present, such as, for example, pedestrians or other vehicles. Therefore, but not limited to, when an obstacle is detected, the speed is changed smoothly and safely so as to rule out any traffic accidents involving the data-collecting vehicle. In addition, but not limited to, the control signal is generated when the movement speed does not correspond to the maximum permissible speed for a vehicle on the given section of the route, wherein the distance to the obstacle is selected so as to allow the movement speed to correspond to the maximum permissible speed for a vehicle on the given section of the route. For example, but not limited to, the vehicle can be equipped with a decision making means adapted to determine at least the approximate distance to an obstacle located on or near the movement trajectory of the data-collecting vehicle and to predict the probability of collision based on the current speed of the data-collecting vehicle in case it does not maneuver; wherein, but not limited to, said decision making means can be adapted to identify the current speed of the data-collecting vehicle and to compare the identified current speed with the maximum permissible speed for the given section of the route; and wherein, but not limited to, when the identified speed is less than the maximum permissible speed for the given section of the route and it is predicted that safe movement at the maximum permissible speed is possible, the control signal disclosed herein is generated. In addition, but not limited to, the control signal is generated when the data-collecting vehicle is not moving and/or its movement is performed without using the engine, at a speed not exceeding 1.4 m/s. For example, but not limited to, while the data-collecting vehicle is moving along a data collection route, a situation may arise, where the vehicle must stop moving in accordance with signals provided by the road infrastructure, such as for example, but not limited to, traffic lights. In addition, but not limited to, upon receiving a signal permitting movement, an estimated movement trajectory for the data-collecting vehicle may be determined, the trajectory including or passing near an obstacle; however, at the same time, the distance to the obstacle is such that safe movement at the maximum permissible speed is possible, but the data-collecting vehicle and, correspondingly, the environmental sensor do not move and, without the control signal, data collection continues, but the data collected are irrelevant or even garbage, which would then have to be deleted; therefore, a control signal is generated, which, for example, but not limited to, causes the data to be marked up so as to separate them from the suitable data, or causes the collected garbage data to be deleted, or even causes the data collected by the environmental sensor not to be written to the dedicated machine-readable storage medium; wherein, but not limited to, when the permitting signal is received and the data-collecting vehicle is able to move again, the generation of the control signal is stopped, including in case an appropriate distance to the obstacle is provided after the data-collecting vehicle has accumulated the maximum permissible speed for the given section of the route. Alternatively, but not limited to, a situation may arise, where the permitting signal and the section of the route require the data-collecting vehicle to move approximately at the speed of the pedestrian flow, preferably, not exceeding 1.4 m/s, which, for example, but not limited to, may be caused by the fact that at the start point of the section of the route, prior to receiving the permitting signal, the data-collecting vehicle was on a trajectory which required the driver to dismount and move the vehicle without using the engine, which, for example, but not limited to, may happen when the vehicle is on the sidewalk in front of a controlled pedestrian crosswalk, and the vehicle's trajectory passes along said crosswalk; wherein, but not limited to, the control signal continues to be generated until the data-collecting vehicle is able to move using its engine.

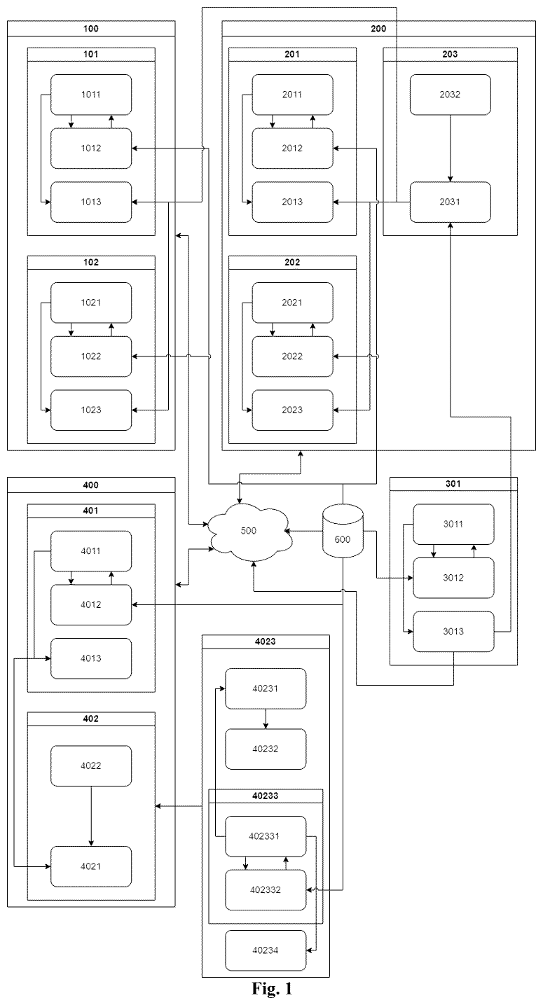

FIG. 1. shows exemplary diagrams of systems 100, 200 for collecting data for machine learning, a diagram of system 300 for training machine learning models, and a diagram of system 400 for controlling a vehicle. According to another preferred embodiment of the present invention, there is provided a system 100 for collecting data for machine learning, the system comprising one or more disclosed data collection devices 101 adapted to generate at least one dataset for machine learning from the data written to the machine-readable storage medium and to send the generated dataset via a wireless communication line, using, for example, a transceiver 1013; a server 102 connected to one or more disclosed data collection devices 101 via a wireless communication line, using, for example, a transceiver 1023, the server comprising at least one or more server's processors 1021, a memory 1022 that stores the program code which, when executed by the server's processor, enables it at least to obtain the at least one dataset and write the obtained dataset to the server's memory 1022; wherein the at least one dataset contains at least one of the raw data, marked up raw data, modified raw data, or a combination thereof; and wherein said dataset does not contain at least the deleted raw data or the data not written to the machine-readable storage medium.

According to another preferred embodiment of the present invention, there is provided a system 200 for collecting data for machine learning, the system comprising one or more disclosed data collection devices 201 adapted to generate at least one dataset for machine learning from the data written to the machine-readable storage medium and to send the generated dataset via a wireless communication line, using, for example, a transceiver 2013; a server 202 connected to one or more disclosed data collection devices 201 via a wireless communication line, using, for example, a transceiver 2023, the server comprising at least one or more server's processors 2021, a memory 2022 that stores the program code which, when executed by the server's processor 2021, enables it at least to obtain the at least one dataset and write the obtained dataset to the server's memory; wherein the at least one dataset contains at least one of the raw data, marked up raw data, modified raw data, or a combination thereof; and wherein said dataset does not contain at least the deleted raw data or the data not written to the machine-readable storage medium; and wherein the system 200 contains one or more vehicles 203 equipped with any disclosed data collection device 201 and at least one environmental sensor 2032, which is connected to the data collection device 101, 201 via, for example, but not limited to, the transceiver 1013, 2013, 2031.

According to another preferred embodiment of the present invention, there is provided a system 300 for training a machine learning model, the system comprising at least one or more devices 301 for training a machine learning model, wherein each device comprises at least one or more processors 3011, a memory 3012 that stores the program code which, when executed by the processor in the device 301 for training a machine learning model, prompts it to execute any of the disclosed methods for training a machine learning model, and one or more disclosed vehicles 203 that collect data for machine learning, which are connected with the device 301, for example, by means of transceivers 3013 and 2031 that can be used to execute any of the disclosed methods for collecting data for machine learning, wherein the device 301 is adapted to use at least the data obtained using said methods to train a machine learning model.

According to another preferred embodiment of the present invention, there is provided a system 400 for determining the permissible speed for a vehicle 402, the system comprising at least one or more devices 401 for determining the permissible speed for a vehicle, wherein each device comprises at least one or more processors 4011 of the device 401, a memory 4012 that stores the program code which, when executed by the processor 4011, prompts it to execute any of the disclosed methods for determining a permissible movement speed for a vehicle 402, and one or more vehicles 402 connected, for example, by means of transceivers 4013, 4021 to any of the disclosed devices 401 for determining the permissible speed for a vehicle and equipped with at least one environmental sensor 4022 adapted to capture any of the disclosed environment frames.

According to another preferred embodiment of the present invention, there is provided a system 4023 for controlling a vehicle that comprises at least an engine 40231 adapted to actuate at least one motor 40232, and at least one vehicle controller 40233, wherein each device comprises at least one or more processors 402331 of the controller 40233, and a memory 402332 that stores the program code which, when executed by the processor in the controller 402331, prompts it to execute any of the disclosed methods for controlling a vehicle 402; the device being adapted at least to generate a control signal for the engine and/or adapted at least to generate an information signal for the information signal 40234 of the vehicle; wherein the control signal is generated using a setting that includes the permissible speed for the vehicle in the given environment frame, and wherein the information signal is generated using the disclosed setting.

In addition, preferably, but not limited to, there is provided a data collection device 101, 201 for collecting data for machine learning, the device comprising at least one or more processors 1011, 2011, and a memory 1012, 2012 that stores the program code which, when executed by the processor 1011, 2011, prompts it to run, in any order, at least the following processes: obtaining raw data from at least one environmental sensor 2032, writing at least a portion of the raw data obtained to a machine-readable storage medium, and receiving a control signal, followed by at least interacting with at least a portion of the raw data being collected. In addition, but not limited to, the environmental sensor 2032 can be an external device connected to the data collection device 101, 201 via a communication line. In addition, but not limited to, the environmental sensor 2032 may be the environmental sensor 2032 of the data-collecting vehicle 203 or it may be mounted on the data-collecting vehicle 203. In addition, but not limited to, the environmental sensor 2032 may be part of any of the devices 101, 201, in which case, correspondingly, the data-collecting vehicle 203 may be equipped with the corresponding device 101, 201. In addition, but not limited to, the machine readable storage medium to which the raw data are written may be either the memory 1012, 2012 of the data collection device or an external data storage device, such as, but not limited to, a database 600 that is connected to the data collection device 101, 201 via a data transfer interface or a wireless communication line 500. In addition, but not limited to, the control signal may be generated either automatically upon receiving a recognition signal after a given environment frame has been processed, or forcibly by means of a signaling device (not shown in the drawing). In addition, but not limited to, the signaling device may not be part of said data collection device, being connected to it via a communication line, e.g. a wireless radio communication line. In addition, preferably, but not limited to, there is provided a signaling device containing a switching means that causes the control signal for the data collection device to be generated when triggered, which, therefore, may serve as an input device.

Therefore, but not limited to, there may be provided a method for training a machine learning model, executed by the system 300, the method comprising using at least one processor 3011 of at least one computer device 301 to train the machine learning model to determine a permissible movement speed for a vehicle 402 based on an environment frame that is inputted into the machine learning model; wherein the environment frame is obtained by means of a data-collecting vehicle 203 equipped with at least one environmental sensor 2032 adapted to capture environment frames; and wherein the machine learning model is trained using the data obtained using any of the disclosed methods for collecting data. In addition, but not limited to, there may be provided a method for determining a permissible movement speed for a vehicle 402, executed by the system 400, the method comprising using at least one processor 4011 of at least one computer device 401 to input an environment frame into the machine learning model, trained using any of the disclosed methods for training a machine learning model, and receiving the permissible movement speed value for a vehicle based on the given environment frame as output. Therefore, in addition, but not limited to, there may be provided a method for controlling a vehicle 402, executed by means of the system 4023, the method comprising using at least one processor 402331 of at least one computer device 40233 to at least identify at least one environment frame; determining, using any of the disclosed methods for determining a permissible movement speed for a vehicle, the permissible movement speed for a vehicle based on the identified environment frame; and at least generating a control signal for the system 4023 for controlling a vehicle, the signal containing at least a setting that includes the determined permissible movement speed for the vehicle based on the given environment frame, which is stored in the memory of the computer device 40233 of the system 4023 for controlling a vehicle.

Therefore, preferably, but not limited to, as is shown in FIG. 1, there may be provided a computer device 101, 201, 301, 401, 40233 that, according to the present disclosure, may be configured as one of the computer device for collecting data, computer device for training a machine learning model, computer device for determining a permissible movement speed for a vehicle, computer device for controlling a vehicle, or a combination thereof. Most typically, said computer device comprises at least one or more processors, and a memory that stores a corresponding program code as disclosed above. At the same time, said computer device can act as a corresponding server of a corresponding system that, therefore, also comprises at least one or more processors and a memory, which are, therefore, essentially identical to the processor(s) and the memory of the computer devices disclosed above, respectively. For example, but not limited to, the memory (computer-readable medium) may comprise a non-volatile memory (NVRAM); a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other magnetic drive; and any other medium capable of storing and encoding the necessary information. In addition, but not limited to, the memory comprises a computer-readable medium based on the computer memory, either volatile or non-volatile, or a combination thereof. In addition, but not limited to, exemplary hardware devices include solid-state drives, hard disk drives, optical disk drives, etc. For instance, but not limited to, the computer-readable medium (memory) is not a temporary memory (i.e. a permanent, non-transitive memory), and therefore it does not contain a temporary (transitive) signal. In addition, but not limited to, the memory may store an approximate environment in which, using computer commands or codes, including those stored in the server's memory, any of the previously disclosed computer procedures, executed by the processor of the computer device, can be performed. In addition, but not limited to, the computer device, if it is not a thin client, contains one or more processors that are designed to execute computed commands or codes that are stored in the device's memory in order to perform the disclosed procedures. In addition, but not limited to, the server, essentially, can be similar to the computer device, if it is not a thin client, and, therefore, contain one or more processors that are designed to execute computed commands or codes that are stored in the server's memory in order to perform the disclosed procedures. In addition, but not limited to, any system disclosed herein may further comprise a database 600. Said database may be, but not limited to, a hierarchical database, a network database, a relational database, an object database, an object-oriented database, an object-relational database, a spatial database, a combination of two or more said databases, etc. In addition, but not limited to, the database at least stores data, parameters, raw data, marked-up data, modified data, machine learning models, and other information in its memory or a suitable memory of another computer device that is connected to any of the disclosed computer devices and/or the server, which may be, but not limited to, a memory that is similar to any of the disclosed memories, and which can be accessed via the server. In addition, but not limited to, there is provided a server, which, in addition to the functions mentioned above, stores and facilitates the execution of computer-readable commands and codes disclosed herein, which, accordingly, won't be described again. In addition, but not limited to, the server, in addition to the functions mentioned above, is capable of controlling the data exchange in the system. In addition, but not limited to, data exchange within the disclosed system is performed with the help of one or more data exchange networks 500. In addition, but not limited to, data exchange networks 500 may include, but not limited to, one or more local area networks (LAN) and/or wide area networks (WAN), or may be represented by the Internet or Intranet, or a virtual private network (VPN), or a combination thereof, etc. In addition, but not limited to, the server is further capable of providing a virtual computer environment for the components of the system to interact with each other. In addition, but not limited to, the network 500 is used to ensure interaction between the computer device, the server, optionally, the database, and, optionally, the systems mentioned above and other systems. In addition, but not limited to, the non-thin client computer device and/or server may be connected to the database directly, using wired or wireless communication methods, which are known in the art and therefore are not described in further detail, or, but not limited to, the database may be implemented in the memory of any computer device, including the server. In addition, but not limited to, a suitable non-thin client computer device can act as a system server for other computer devices, which are thin clients. In addition, but not limited to, most typically, the components of the computer devices disclosed herein and the server components are interconnected, including though some kind of data bus.

In addition, but not limited to, the vehicle 203, 402 may be temporarily rented, the use of said vehicle being provided by means of the system for enabling personal use of vehicles on demand.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A method for training a machine learning model, executed by a processor or processors of a computer device, the method comprising using the at least one processor of the at least one computer device to train the machine learning model to determine a permissible movement speed for a vehicle based on an environment frame that is inputted into the machine learning model;
wherein the environment frame is obtained by means of a vehicle equipped with at least one environmental sensor adapted to capture environment frames;
wherein the machine learning model is trained using data that have been obtained using a method for data collection, the method comprising at least the following steps:
obtaining raw data for machine learning using the at least one environmental sensor, and
writing at least a portion of the raw data obtained to a machine-readable storage medium using a data collection device; and
wherein, in the process of data collection, a control signal for the data collection device is generated,
the control signal containing at least one instruction for the processor of the data collection device, the at least one instruction is capable of prompting said processor to execute a program code which, when executed by the processor, interacts with at least a portion of the raw data being collected.

2. The method of claim 1, wherein the interactions include at least marking up and/or modifying at least a portion of the raw data being written to the machine-readable storage medium, and/or deleting at least a portion of the raw data and/or data suitable for machine learning written to the machine-readable storage medium, and/or not writing at least a portion of the raw data being collected to the machine-readable storage medium.

3. The method of claim 2, wherein the data are collected using a data collection device that is connected to the at least one environmental sensor or comprises the at least one environmental sensor.

4. The method of claim 1, wherein the environmental sensor is selected from or is formed by a radar, a lidar, a sonar, a camera, or a combination thereof.

5. The method of claim 4, wherein the environmental sensor is moved around by means of a data-collecting vehicle.

6. The method of claim 5, wherein movement is performed at least concurrently with the regular traffic flow and/or the regular pedestrian and traffic flow, wherein movement speed is selected so as not to exceed the maximum permissible speed for a vehicle on a given section of a route.

7. The method of claim 6, wherein the movement speed is changed at least depending on the distance to an obstacle.

8. The method of claim 1, wherein the control signal is generated when the movement speed does not correspond to the maximum permissible speed for a vehicle on a given section of a route, wherein the distance to an obstacle is selected so as to allow the movement speed to correspond to the maximum permissible speed for a vehicle on the given section of the route.

9. The method of claim 1, wherein the control signal is generated when there is no movement and/or the movement is performed without using an engine, at a speed not exceeding 1.4 m/s.

10. The method of claim 1, wherein the control signal is generated by means of a signaling device that is connected to or equipped on the data collection device.
